(19) United States
(12) Patent Application Publication
(10) Pub. No.: US 2012/0257924 A1
(43) Pub. Date: Oct. 11, 2012

(54) MOLDED ATTACHMENT CLIP

(76) Inventor: Jeffrey Andrews, Cottam (CA)

(21) Appl. No.: 13/080,935

(22) Filed: Apr. 6, 2011

(51) Int. Cl. F16B 5/06

(52) U.S. Cl. 403/381

(57) ABSTRACT

A molded attachment clip for securing a member to a body. The clip including a primary support and a pair of retention tabs extending from the primary support. The retention tabs extend away from the primary support member, each retention tab is biased toward a non-deflected position away from the primary support. A recess is formed at a terminal end of each retention tab, each recess defined by a bearing surface and an abutment surface. During insertion of the attachment clip into an aperture of the body, the retention tabs are deflected toward the primary support to a deflected position through contact with a surface defining the aperture. The bearing surface slidingly engages the surface defining the aperture and the abutment surface engages another surface of the body proximate the aperture as the retention tabs are biased to return toward their non-deflected position wherein the member is joined to the body.

### FIELD

The present invention relates to an attachment clip for joining two or more parts.

### BACKGROUND

When attaching a part, for example, to a body of a vehicle, various standards may exist for attaching the part to the body. In this regard, standards for maximum insertion forces of attachment members used to attach the part to the body exist so that assemblers in a manufacturing facility do not exert unnecessary force when joining the parts. Some standards call for a maximum insertion force of about twenty-four pounds. When forces exceed this standard, the assemblers may damage the parts such as the attachment member and molding or sheet metal parts to be assembled. It is therefore desirable to reduce the occurrence of damage the parts, while maintaining a sufficient retention force when the parts are joined.

### SUMMARY

In one aspect of the present disclosure, a molded attachment clip for securing a member to a body is provided. The clip includes a primary support and a pair of retention tabs extending from an end of the primary support. Each retention tab is biased toward a non-deflected position away from the primary support. A recess is formed at a terminal end of each retention tab, each recess defined by a bearing surface and an abutment surface. During insertion of the attachment clip into an aperture of the body, the retention tabs are deflected toward the primary support to a deflected position through contact with a surface defining the aperture. The bearing surface slidingly engages the surface defining the aperture and the abutment surface engages another surface of the body proximate the aperture as the retention tabs are biased to return toward their non-deflected position wherein the member is joined to the body.

In another aspect of the present disclosure, a molded member including an integral attachment clip for securing the molded member to a vehicle body is provided. The molded member includes a first support, a second support and a pair of deflectable retention tabs. The first support extends substantially perpendicular to a surface of the molded member. The second support extends substantially perpendicular to the surface of the molded member and substantially transverse to the first support. The pair of deflectable retention tabs is secured to an end of the first support. Each of the retention tabs is biased toward a non-deflected position away from the first support. Each of the retention tabs have a deflected position as the attachment clip is inserted into an aperture of the body. Each retention tab includes a recess that contacts a surface of the aperture to secure the attachment clip to the body and prevent the retention tabs from fully returning to the non-deflected position.

Further areas of applicability of the teachings of the present disclosure will become apparent from the detailed description, claims and the drawings provided hereinafter. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a perspective view of an attachment clip according to a principle of the present disclosure;

FIG. 2 is a perspective view of an attachment clip according to a principle of the present disclosure;

FIG. 3 is a perspective view of another attachment clip according to a principle of the present disclosure;

FIG. 4 is a perspective view of an assembly utilizing the attachment clip illustrated in FIG. 3; and

FIG. 5 is a cross-sectional view of a molded member having embodiments of the attachment clips illustrated in FIGS. 1-4, utilized to secure the molded member to a body of a vehicle.

### DETAILED DESCRIPTION

FIGS. 1-5 illustrate molded attachment clips 10 and 48 according to the present disclosure for joining two or more parts. In general, attachment clips 10 and 48 may be formed of an injection-molded plastic material such as polypropylene, polyamide, polystyrene, or other plastic materials known in the art. The plastic material may also be a glass-filled plastic material to provide suitable strength and rigidity to the attachment device, while maintaining flexibility of the material. Alternatively, the attachment clips may be formed of a metal material.

Attachment clips 10 and 48 may be unitary with a base member 12 to be attached to, for example, a vehicle. Base member 12, for example, may be a molded interior trim piece for the vehicle, or an exterior trim piece for the vehicle, without limitation. Alternatively, attachment clips 10 and 48 may be pre-molded and subsequently attached to molded member 12 via plastic welding or some other attachment method.

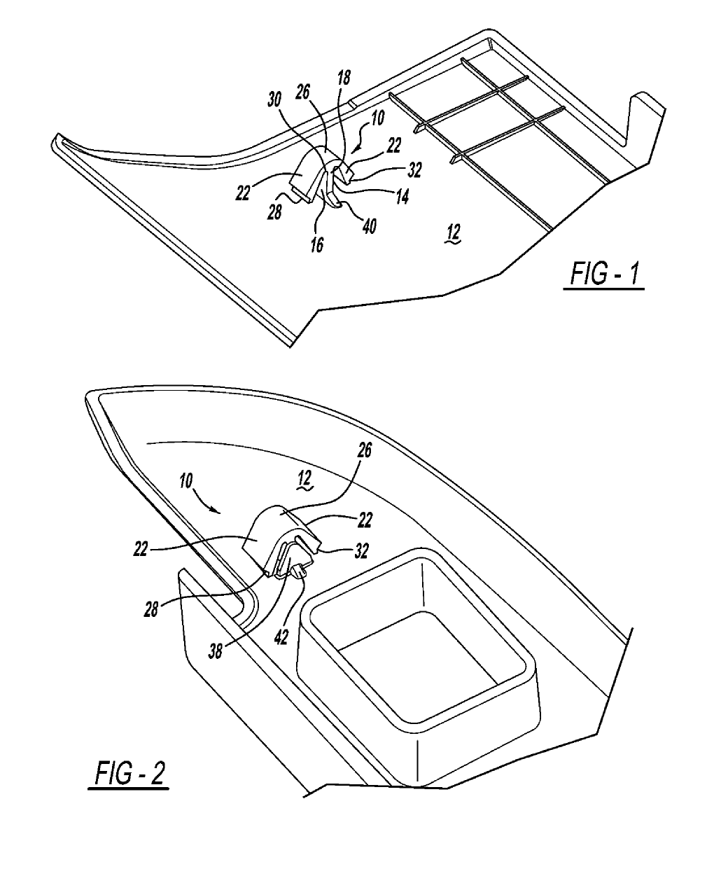

Referring to FIGS. 1 and 2, attachment clip 10 includes a support 14 (hereinafter primary support 14) that includes a proximal end 16 secured to base member 12 and a distal end 18 distal from base member 12. In one exemplary embodiment, primary support 14 extends substantially perpendicular to base member 12. At distal end 18 of the primary support is formed a pair of deflectable retention tabs 22.

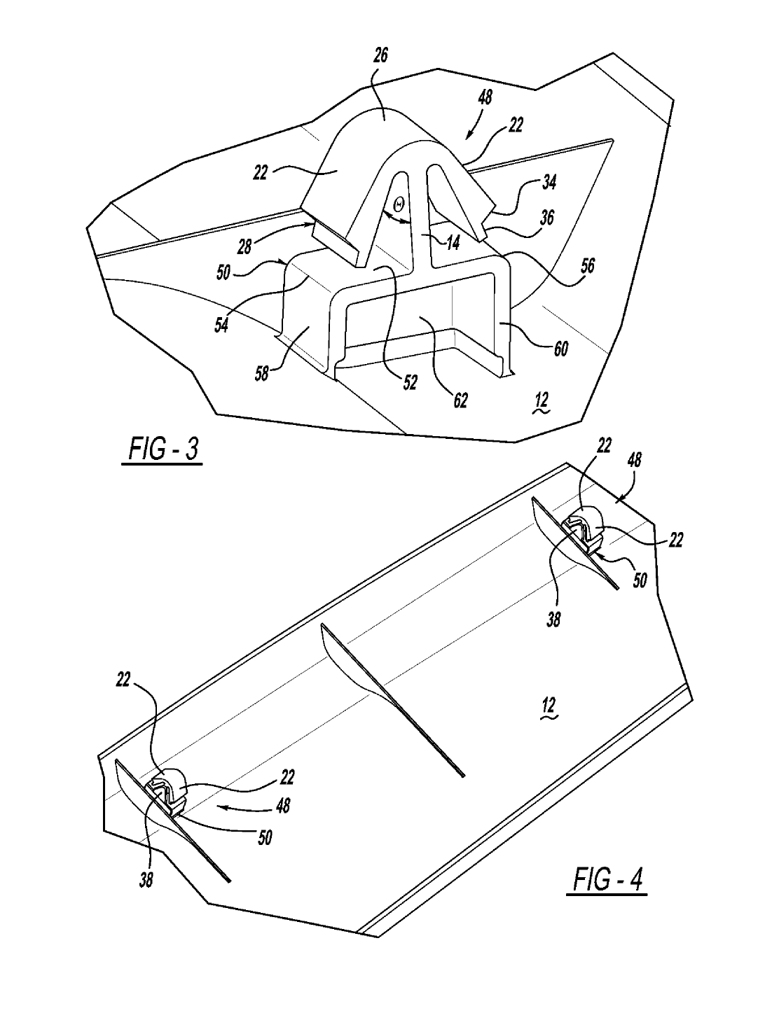

Retention tabs 22 extend angularly downward from distal end 18 of primary support 14 toward base member 12. Here, retention tabs 22 are generally planar members having a width substantially equal to a width of the generally planar primary support 14. Retention tabs 22 each include an end portion biased away from the primary support, i.e. biased toward a non-deflected position. When the retention tab is in a deflected position the retention tab including the end portion is moved toward the primary support. An angle θ (best shown in FIG. 3) at which retention tabs 22 extend away from primary support 14 may range between 15 and 75 degrees. Preferably, angle θ ranges between 30 and 60 degrees. More preferably, angle θ ranges between 35 and 45 degrees. It should be understood, however, that retention tabs 22 may be at any angle θ relative to primary support 14 so long as retention tabs 22 are operable to deflect during insertion into aperture 24 formed in body part 25 of the vehicle, and subsequently the retention tabs 22 return toward or to a non-deflected position after insertion into the aperture.

Retention tabs 22 may be connected to each other by a surface 26 having a radius of curvature. It should be understood, however, that retention tabs 22 may be connected in a manner such that surface 26 does not include a radius of curvature. That is, retention tabs 22 may be connected to each other in a linear manner such that a pointed area (not shown) co-planar with primary support 14 is formed. In some embodiments, surface 26 can be configured to aid in the insertion of the retention tabs into the aperture of the body part, e.g. complimentary surfaces such as substantially similar chamfers or curved surfaces.

Retention tabs 22 may be formed to have a variable thickness and shape. As retention tabs 22 extend angularly downward relative to primary support 14, a thickness of retention tabs 22 may increase. By having a thickness of retention tabs 22 at distal end 18 of primary support 14 less than a thickness of retention tabs 22 at a terminal portion 28 thereof, retention tabs 22 can be more easily deflectable at pivot point 30 during insertion of attachment clip 10 into aperture 24. The thickness of the retention tabs along their length, the angle θ, the radii at the angle θ, the thickness of the primary support member, the material of the clip, desirable insertion and retention forces, the number of parts to be secured by the clip, the expected times the clip is to be installed and removed (fatigue) are some of the factors to be considered to determine the configuration of the clip.

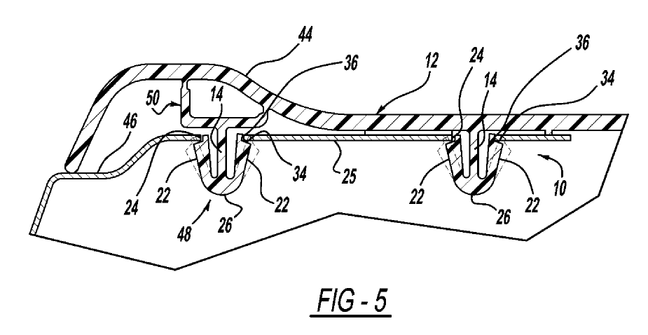

For instance, while it may be desirable to have a high retention force, it may not be desirable to have a high insertion force that could place undue burden on the installer, and lead to part breakage, etc. Although insertion could be made easier by having a smaller angle and a thinner tab thickness proximate the radii at the angle θ. Additionally, surfaces 34, 36 of the retention tabs can be configured to account for the variation, including tolerances, of the aperture through which the retention tabs are inserted, formed aperture surface roughness, etc. In some embodiments, surfaces 34, 36 can include multiple contours along the surface 34, 36 widths to mate to complimentary multiple surfaces of the aperture. Such as in one non-limiting example, where the aperture has a rectangular shape with a stepped contour along one or more sides of the rectangular aperture. In some embodiments, the retention tabs including in particular surfaces 34 and/or 36 can be configured to minimize over travel of the tabs as they protrude though the aperture, as is shown for example in FIG. 5 when the tabs deflect outward after insertion through the aperture, a portion of the tab abuts such as surface 36 abuts against a surface of the aperture.

Terminal portion 28 of each retention tab 22 may include a recess 32 formed along a width of retention tab 22. Recess 32 is defined by a bearing surface 34 and an abutment surface 36. Abutment surface 36 engages a surface defining aperture 24 upon insertion of attachment clip 10 therein. More particularly, as the attachment clip is inserted into aperture 24, retention tabs 22 are operable to deflect inward toward primary support 14. After a portion of retention tabs 22 has passed through aperture 24, retention tabs 22 will begin to return toward their non-deflected position. In some exemplary embodiments, as retention tabs 22 reach their installed position, abutment surface 36 will engage a surface of aperture 24 and bearing surface 34 will engage a surface of the part to which the attachment clip is then secured thereto (the part having the aperture configured to receive the retention tabs therethrough).

In another exemplary embodiment, at the installed position the abutment surface 36 and the bearing surface 34 will both engage surface(s) of the aperture. At the installed position of the attachment clip to the aperture, the retention tabs 22 are precluded from fully returning to a non-deflected state, although in certain other embodiments the retention tabs may fully return to their non-deflected position where the clip is secured to the body part. Notwithstanding, bearing surface 34 also acts as an engagement surface that precludes the attachment clip from being disengaged from aperture 24 unless retention tabs 22 are moved to a deflected position toward primary support 14 in a manner to separate the attachment clip from the other part (e.g. here body part of the vehicle). Attachment clip 10, therefore, is utilized to securely attach base member 12 to another part or body of the vehicle.

To provide additional strength to attachment clip 10, a second support 38 (hereinafter secondary support 38) may be provided. Secondary support 38 is substantially planar and extends substantially perpendicular to base member 12, and is oriented substantially transverse to primary support 14. Secondary support 38 provides rigidity to attachment clip 10 so that during insertion of attachment clip 10 into aperture 24, if excessive force is applied to attachment clip 10, attachment clip 10 will not buckle or otherwise be compromised so the clip will not be capable of performing its intended function. For example, use of secondary support 38 that is substantially transverse to primary support 14 may prevent primary support 14 from buckling during insertion of attachment clip 10 into aperture 24.

Secondary support 38, although integral with primary support 14, is offset relative to retention tabs 22. Offsetting secondary support 38 from retention tabs 22 allows them to deflect upon insertion of attachment clip 10 into aperture 24. In some embodiments, secondary support 38 may be substantially triangular in shape. Making secondary support 38 substantially triangular in shape may allow secondary support 38 to fit entirely through aperture 24, without interfering with deflection of retention tabs 22. It should be understood, however, that secondary support 38 may be any shape desired so long as additional support is provided to primary support 14 and edges of secondary support 38 do not interfere with insertion of attachment clip 10 through aperture 24. That is, secondary support 38, being offset relative to retention tabs 22, should also not project toward the retention tabs to an extent to impede adequate deflection of the retention tabs as they are deflected inward toward primary support 14 when attachment clip 10 is inserted into or removed from aperture 24.

To assist in orientating attachment clip 10, the clip may include a pair of projections or flats 40 and 42. As illustrated in FIGS. 1 and 2, respectively, flat 40 extends outward relative to primary support 14, while flat 42 extends outward secondary support 38. Flats 40 and 42 are angled relative to base member 12 and can assist in locating attachment clip 10 in a predetermined orientation. In this regard, aperture 24 may include correspondingly-shaped areas (not shown) that mate with flats 40 and 42 when attachment clip 10 is inserted into aperture 24. Flats 40 and 42, therefore, can ensure that base member 12 is correctly mounted relative to body 25 of the vehicle.

As illustrated in FIG. 5, base member 12 may be designed to have a varying contour 44 that provide differences in distance between base member 12 and an attachment surface 46 of body 25. To account for these different distances, attachment clip 48 of FIG. 5 may be provided. Attachment clip 48 is substantially similar to attachment clip 10 illustrated in FIGS. 1 and 2 and described above. In this regard, attachment clip 48 also includes features such as primary support 14, retention tabs 22, and secondary support 38. As these features were described in detail above, description of these features will be not discussed here. Attachment clip 48 further includes a support section 50.

Support section 50 includes a base member 52 that may be arranged substantially in parallel with a surface of base member 12, and is substantially perpendicular to primary support 14 and secondary support 38. Opposing ends 54 and 56 of base member 52 and integral therewith may support legs 58 and 60. Support legs 58 and 60 may each be substantially equal in length or, alternatively and as shown in FIG. 3, may be different in length to account for the varying contour 44. Regardless, it should be understood that support section 50 may be sized to account for any difference in distance between base member 12 and attachment surface 46.

Disposed between support legs 58 and 60 may be a support panel 62 that may entirely traverse the distance between support legs 58 and 60. Support panel, in a manner similar to secondary support 38, provides increased strength and rigidity to support section 50 so that when attachment clip 48 is inserted into aperture 24, support legs 58 do not buckle when subjected to the insertion loads.

As described above, attachment clips 10 and 48 are designed to be easily inserted into aperture 24 when attaching base member 12 to a part (e.g. vehicle body 25). In this regard and in an exemplary embodiment, attachment clips 10 and 48 are configured (including the deflection of the retention tabs) and operable to be inserted into aperture 24 with a force of six pounds. In certain embodiments, the attachment clip is configured so the insertion force is less than six pounds, while in other embodiments the insertion force is greater than six pounds. In many embodiments the attachment clips are configured so the insertion force is substantially less than twenty-four pounds, a range that may be often utilized when securing parts together via an insertion force. Accordingly, assemblers in a manufacturing facility do not need to use an excessive insertion force when attaching base member 12 to body 25 and, therefore, degradation to base member 12, the attachment clip, and body 25 is prevented, or at least substantially minimized.

The attachment clip is configured to maintain the joined parts securely together (for example, due to contact between the surface of the aperture and the surfaces of the recessed area 32) until deflecting the retention tab in a manner to disengage the attachment clip, and member, from the body. It should be understood that attachment clips 10 and 48 are also configured so the clips can be easily removed from aperture 24 by simply deflecting retention tabs 22 toward primary support member 14.

In certain embodiments it is contemplated that an attachment clip can be configured to secure more than two parts together. For example, one part includes a configured molded attachment clip to be utilized to join the part to two other parts each of the two parts having an aperture configured to receive retention tabs of the clip as discussed above including a recess portion configured to abut at least a portion of a surface of the aperture(s) when the clip is assembled. In another example, a multiple contoured third part can be positioned between parts 12 and 25 shown in FIG. 5, where the third part would also have apertures configured to receive the clips for securement of the three part assembly.

What is claimed is:

1. A molded attachment clip for securing a member to a body, the molded attachment clip comprising:
a primary support;
a pair of deflectable retention tabs extending from an end of said primary support, each of said retention tabs being biased toward a non-deflected position away from said primary support; and
a recess formed at a terminal end of each retention tab, each of said recesses defined by a bearing surface and an abutment surface,
wherein during insertion of the attachment clip into an aperture of the body, said retention tabs are deflected toward said primary support to a deflected position through contact with a surface defining the aperture, and said bearing surface slidingly engages said surface defining said aperture and said abutment surface engages another surface of the body proximate the aperture as the retention tabs are biased to return toward their non-deflected position wherein the member is joined to the body.

2. The molded attachment clip of claim 1, wherein said retention tabs have a variable thickness.

3. The molded attachment clip of claim 1, wherein said retention tabs have a width substantially equal to a width of said primary support.

4. The molded attachment clip of claim 1, further comprising a planar secondary support oriented transverse to said primary support.

5. The molded attachment clip of claim 4, wherein said secondary support is offset relative to said retention tabs to allow said retention tabs to deflect between said non-deflected position and said deflected position.

6. The molded attachment clip of claim 4, wherein said secondary support is shaped to allow at least a portion of the attachment clip to pass through the aperture.

7. The molded attachment clip of claim 1, further comprising a support section.

8. The molded attachment clip of claim 1, wherein said retention tabs are angled relative to said primary support at an angle ranging between 30 and 75 degrees.

9. The molded attachment clip of claim 1, further comprising at least one projection formed at an end of said primary support proximate the member.

10. A molded member including an integral attachment clip for securing the molded member to a vehicle body, the molded member comprising:
a first support extending substantially perpendicular to a surface of the molded member;
a second support, said second support extending substantially perpendicular to said surface of the molded member and substantially transverse to said first support; and
a pair of deflectable retention tabs secured to an end of said first support, each of said retention tabs being biased toward a non-deflected position away from said first support, and each of said retention tabs having a deflected position as the attachment clip is inserted into an aperture of the body, and each retention tab including a recess that contacts a surface of the aperture to secure the attachment clip to the body and prevent said retention tabs from fully returning to said non-deflected position.

11. The molded member of claim 10, wherein said retention tabs have a variable thickness.

12. The molded member of claim 10, wherein said retention tabs have a width substantially equal to a width of said first support.

13. The molded member of claim 12, wherein said second support is offset relative to said retention tabs to allow said retention tabs to deflect without interference.

14. The molded member of claim 10, wherein said second support is shaped to allow the attachment clip to pass through the aperture.

15. The molded member of claim 10, further comprising a support section.

16. The molded member of claim 10, wherein said retention tabs are angled relative to said first support at an angle ranging between 30 and 75 degrees.

17. The molded member of claim 10, further comprising a projection formed at an end of said first support proximate a surface of the molded member.

18. The molded member of claim 17, further comprising a projection formed at an end of said second support.

19. The molded member of claim 10, further comprising a third part positioned between the molded member and the vehicle body, wherein the third part includes an aperture configured to receive portions of the attachment clip.
